(19) United States
(12) Patent Application Publication
(10) Pub. No.: US 2025/0326127 A1
(43) Pub. Date: Oct. 23, 2025

(54) REMOTE ROBOT CONTROL SYSTEM

(71) Applicant: ARA Co., Ltd., Cheonan-si (KR)

(72) Inventors: JIN BAE KIM, Cheonan-si (KR); AE JIN KIM, Asan-si (KR)

(21) Appl. No.: 19/087,568

(22) Filed: Mar. 23, 2025

(30) Foreign Application Priority Data
Apr. 19, 2024 (KR) 10-2024-0052614

(51) Int. Cl. B25J 9/16; B25J 19/06

(52) U.S. Cl. CPC B25J 9/1697; B25J 9/1674; B25J 19/061

(57) ABSTRACT

Provided is to a remote robot control system. In addition, provided is a remote robot control system for controlling a robot, including: a robot control unit configured to select at least one controller and control the robot according to a control command input from the selected controller; a state display unit configured to display information about states of the robot and the controller; and an image output unit configured to receive image data from an image photographing device installed in the robot or installed around the robot and output the received image data in real time when the robot operates according to the control command, so that a worker or manager may select a desired controller to control the robot, and limitation of a working range may be minimized by using a remote client based on wireless communication.

### BACKGROUND OF THE INVENTION

### 1. Field of the Invention

The present invention relates to a remote robot control system.

### 2. Description of the Related Art

In general, the use of industrial robots is rapidly increasing due to the increase in manufacturing process size, linearization, and automation facilities in industrial sites. In addition to these industrial robots, various types of robots are widely used throughout modern industries according to rapid development and change.

However, in the related art, when a problem occurs in the operation and driving of a robot including an industrial robot, there is a problem in that a general user, not an expert or mechanic related to the robot, may not take measures such as solving the problem of the robot.

In particular, there is a problem in that the expert or mechanic related to the robot are unable to take measures because the technology is not provided to remotely grasp the state of the robot.

Meanwhile, pendants dedicated to each robot are used for the operation of the industrial robot.

The pendant is a device for controlling a robot through a manual operation and a program operation, and includes an LCD screen and a key, and the LCD screen is used as a touch panel and includes an emergency stop button, a jog dial, a mode change switch, a motor key, a lock key, a robot selection key, an operation mode key, a speed key, a cursor key, a stop key, an OK key, and the like.

However, as one pendant is configured to be connected to one robot, a plurality of pendants are required to control each robot in a factory in which a plurality of robots are installed, and when a heterogeneous robot is used, a dedicated pendant is required for each robot model, and thus there is a problem in that the cost for having a pendant increases.

In addition, the conventional pendant is connected to the robot by wire, thereby limiting a working range of a worker or a manager, and there is a problem in that the worker or the manager may not provide a method of controlling the robot using another device, for example, a computer or a tablet PC.

### SUMMARY OF THE INVENTION

The present invention has been devised in consideration of the above problems, and an object of the present invention is to provide a remote robot control system capable of remotely grasping a state of a robot and taking measures to solve the problem.

In addition, an object of the present invention is to provide a remote robot control system capable of minimizing a limitation of a working range and controlling a robot by selecting a desired controller by a worker or manager.

The objects of the present invention are not limited to the above-described objects, and other objects that are not described will be clearly understood by those skilled in the art from the following description.

To achieve the above objects, the present invention provides a remote robot control system for controlling a robot including: a robot control unit configured to select at least one controller and control the robot according to a control command input from the selected controller; a state display unit configured to display information about states of the robot and the controller; and an image output unit configured to receive image data from an image photographing device installed in the robot or installed around the robot and output the received image data in real time when the robot operates according to the control command.

In the preferred embodiment, the remote robot control system may further include an alarm output unit configured to receive one or more alarms for an abnormal state from the robot, output the received alarms, and stop an alarm that is previously output.

In the preferred embodiment, the remote robot control system may further include an operation range setting unit configured to set a basic position of the robot, set an operable range for each axis in terms of orthogonal coordinates and link coordinates, and set a driving limitation section with respect to at least one axis of the robot.

In the preferred embodiment, the remote robot control system may further include a driving speed setting unit configured to set a driving speed of the robot, in which the driving speed is set as a driving speed in association with orthogonal coordinates and a driving speed in association with link coordinates.

In the preferred embodiment, the remote robot control system may further include a controller setting unit configured to display a list of connectable controllers, set a connection with a corresponding controller to allow the robot control unit to select the corresponding controller, and display an operation state of the controller that has been connected.

In the preferred embodiment, the robot control unit may display a type of a controller that is currently selected, select driving coordinates of the robot, display position information about the robot according to the selected driving coordinates, and provide an operation button for inputting the control command.

In the preferred embodiment, the state display unit may further display an operation log including a change in connection states of the robot and the controller while displaying the connection states of the robot and the controller.

Through the “Technical Solution” described above, according to the present invention, the worker or the manager may control the robot by selecting a desired controller, and a limitation of the working range may be minimized by using a remote client based on wireless communication.

In addition, according to the present invention, information about states of the robot and the controller and image data is provided to grasp problems such as operation and driving of the robot, and remote control of the robot is possible through the controller, so that the expert or mechanic related to the robot may remotely grasp the state of the robot and take measures.

### BRIEF DESCRIPTION OF THE DRAWINGS

FIG. 1 is a diagram for a remote robot control system according to the present invention.

FIG. 2 is a block diagram showing a hardware configuration of the remote robot control system according to the present invention.

FIG. 3 is a block diagram showing a function performed by a processor of the remote robot control system according to the present invention.

FIG. 4A is a diagram showing a control interface provided by the remote robot control system and

FIGS. 4B to 4E are enlarged views showing portions of FIG. 4A.

FIG. 5A is a diagram showing a control interface provided by the remote robot control system and FIGS. 5B to 5F are enlarged views showing portions of FIG. 5A.

FIG. 6A is a diagram showing a control interface for a controller provided from the remote robot control system to the controller and FIGS. 6B to 6C are enlarged views showing portions of FIG. 6A.

### DETAILED DESCRIPTION OF THE INVENTION

In the following description, specific details of the present invention are shown to provide a general understanding of the present invention, and it will be apparent to those skilled in the art that the present invention may be readily practiced without the specific details and with variations thereof.

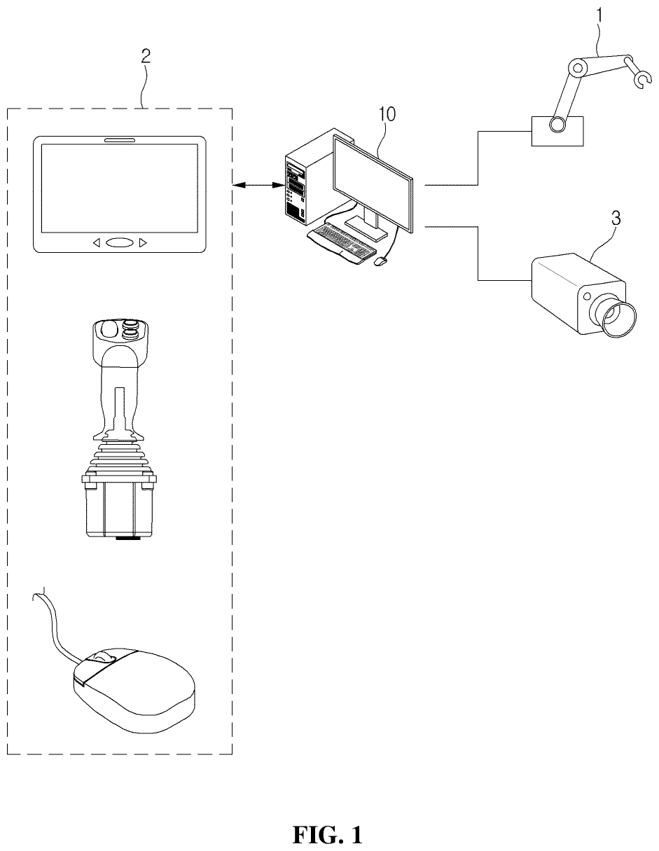

Hereinafter, the preferred embodiments according to the present invention will be described in detail with reference to the accompanying FIGS. 1 to 6C, and a description will be described focusing on parts necessary to understand the operation and effect according to the present invention.

FIG. 1 is a diagram for a remote robot control system according to the present invention.

Referring to FIG. 1, a remote robot control system 10 according to one embodiment of the present invention is to control a robot 1, and may be implemented as a server or computing device that is accessible through a wired network, a wireless network, or the Internet, or may be implemented as a program installed in the server or computing device.

In the remote robot control system 10 according to one embodiment of the present invention, the robot 1 to be controlled may be connected by wire, a controller 2 for inputting a control command for the robot 1 may be connected to the remote robot control system 10, and at least one image photographing device 3 may be connected to the remote robot control system 10.

In this case, the above-described controller 2 may be selected from a remote client including a tablet PC, a joystick, and a mouse, and when the remote client is selected, the robot 1 may be remotely controlled based on wireless communication, and when all kinds of controllers 2 are connected, control priorities may be set in the order of the remote client, the joystick, and the mouse.

Further, the above-described image photographing device 3 may be installed on the robot 1 or around the robot 1, may photograph an operation state or operation situation of the robot 1, and may provide the photographed image data to the remote robot control system 10.

As described above, the remote robot control system 10 according to one embodiment of the present invention allows a worker or a manager to select a desired controller 2 to control the robot 1, and at the same time, minimizes a limitation of a working range using the remote client based on wireless communication.

Hereinafter, a hardware configuration of the remote robot control system 10 according to one embodiment of the present invention will be described.

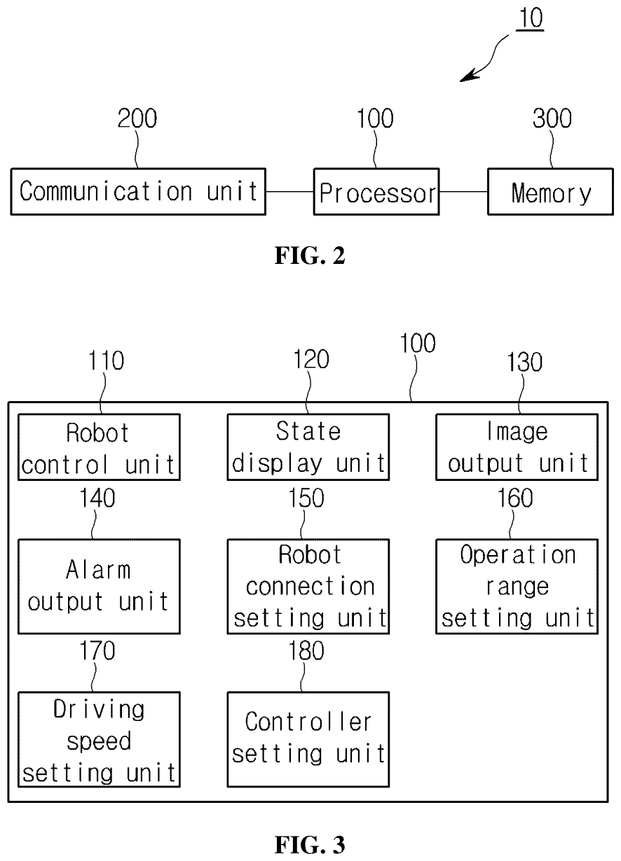

FIG. 2 is a block diagram showing a hardware configuration of the remote robot control system according to the present invention.

Referring to FIG. 2, the remote robot control system 10 according to one embodiment of the present invention may include a processor 100, a communication unit 200, and a memory 300.

The remote robot control system 10 may include one or more processors 100, in which the one or more processors 10 may execute one or more instructions or programs stored in the memory 300, control an overall operation of the remote robot control system 10, and perform various data processing or operations.

The processor 100 may select the controller 2, control the robot 1 according to the control command input from the controller 2, and perform an operation such as receiving the image data from the image photographing device 3 and outputting the image data when the robot 1 operates according to the control command.

The communication unit 200 is for communication with the robot 1, the controller 2, and the image photographing device 3, and may include one or more components that enable communication with an external device, and may include, for example, at least one of a wired communication module, a wireless communication module, and a short-range communication module.

The communication unit 200 may communicate with the robot 1 to transmit the control command and receive an alarm for an abnormal state, communicate with the controller 2 to receive the control command for the robot 1, and communicate with the image photographing device 3 to receive the image data.

In addition, the communicator 200 may receive a user input from another electronic device or a server through a network, or may receive data stored in another electronic device or a server.

The memory 300 may store one or more instructions executable by the processor 100 or may store programs executed by the processor 100.

Specifically, the memory 300 may store commands or data related to at least one component of the processor 100. The above-described data may include input data or output data for a program and a command related thereto. The above-described program may be stored in the memory 300 as software, and may include an operating system, middleware, or an application.

Hereinafter, functions performed by the processor 100 in the remote robot control system 10 according to one embodiment of the present invention will be described in detail.

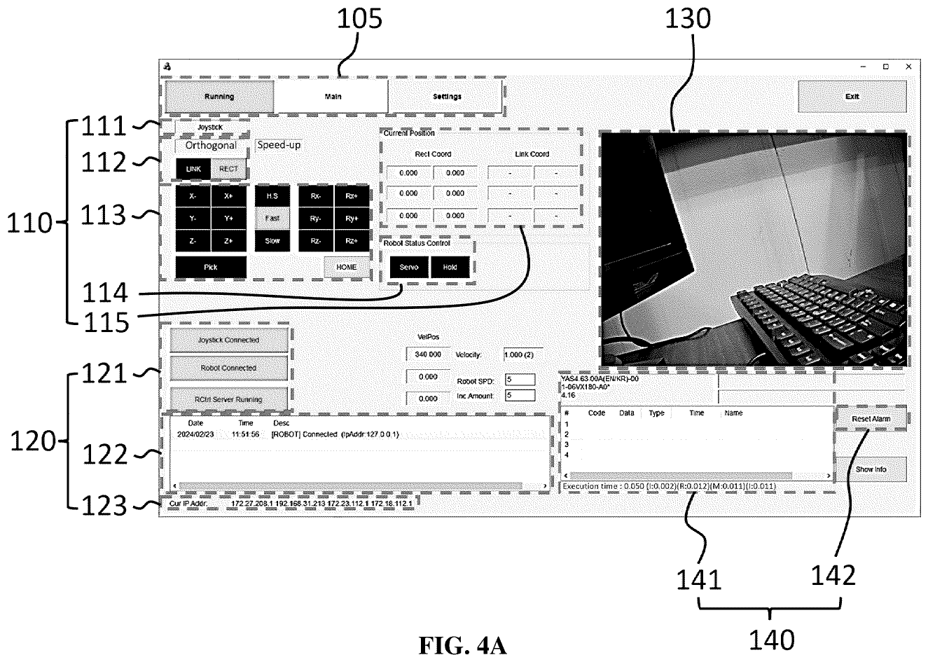

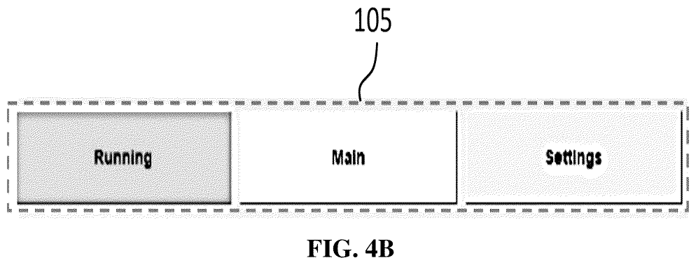

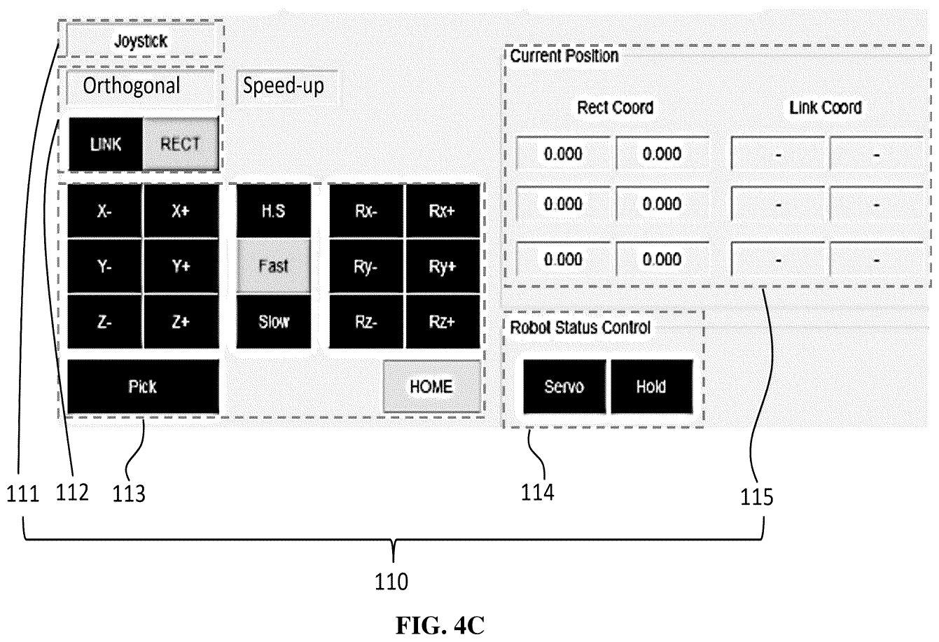

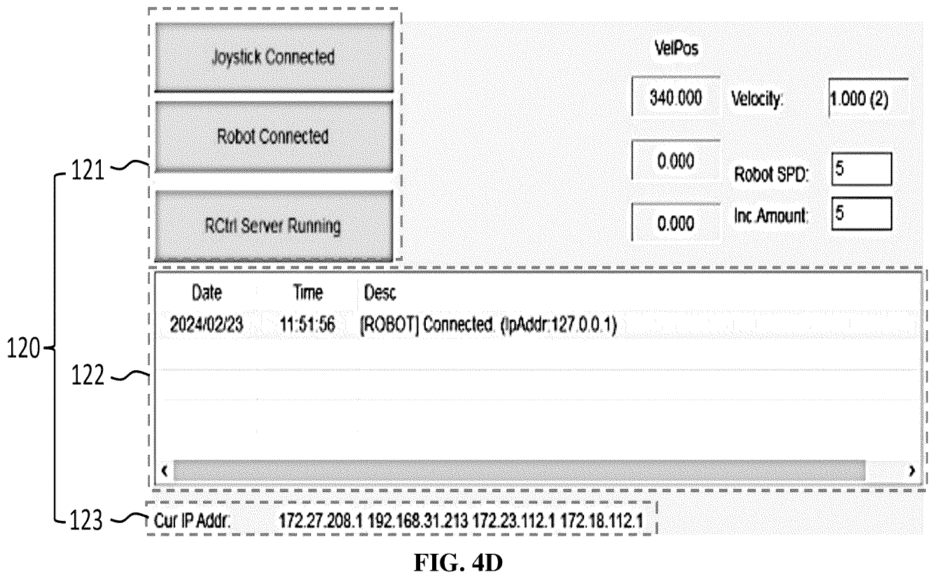

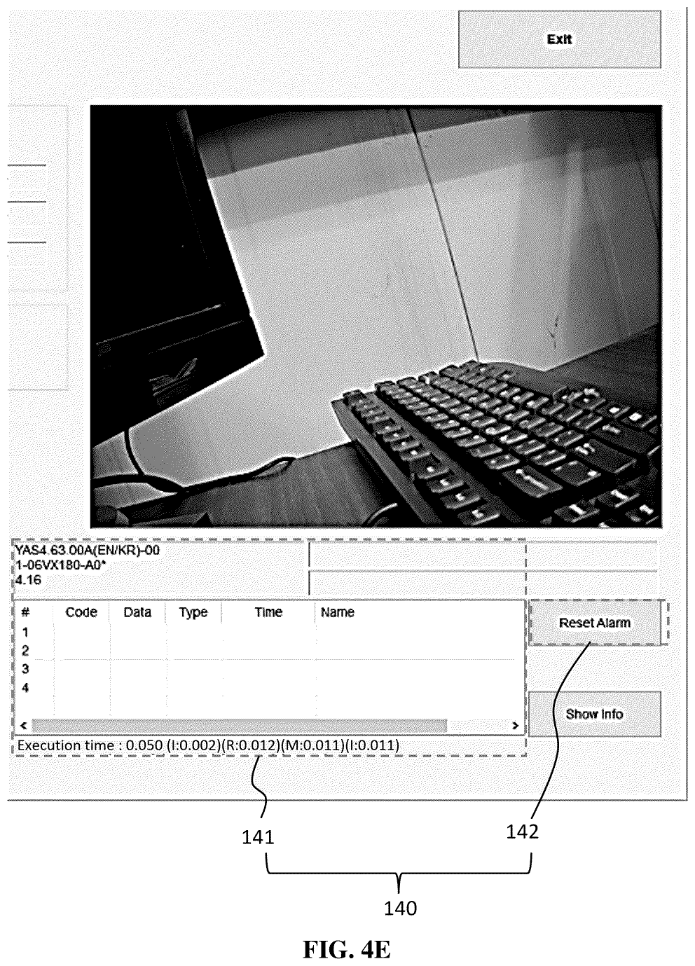

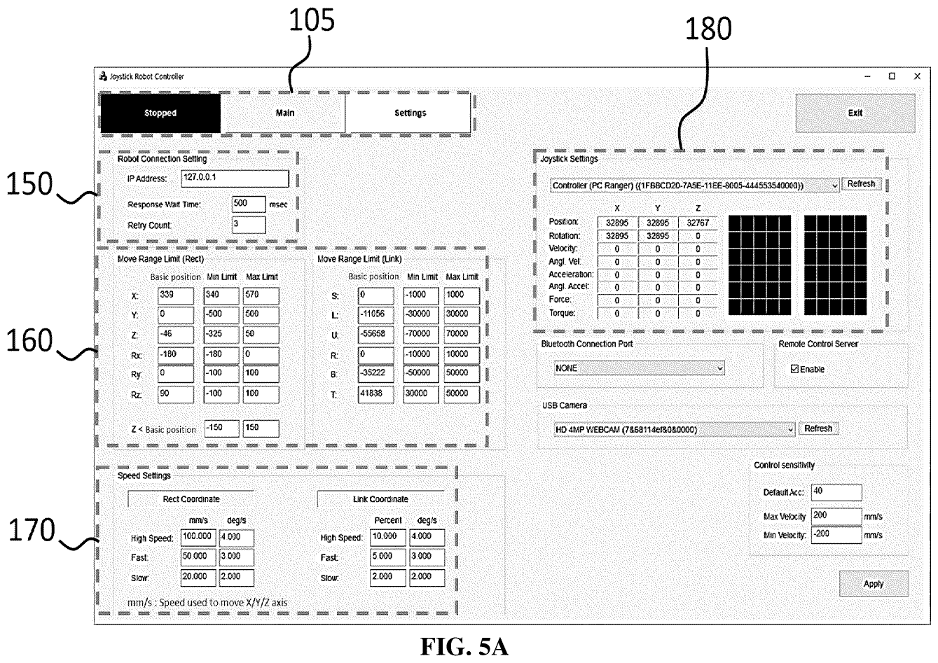

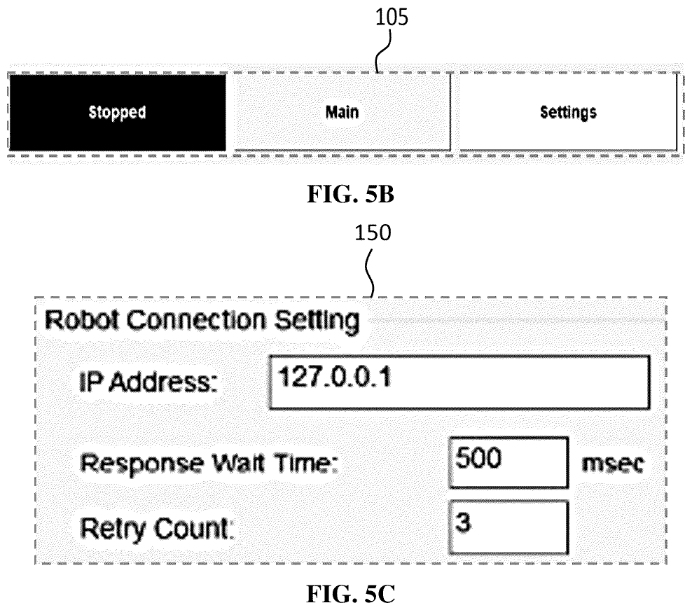

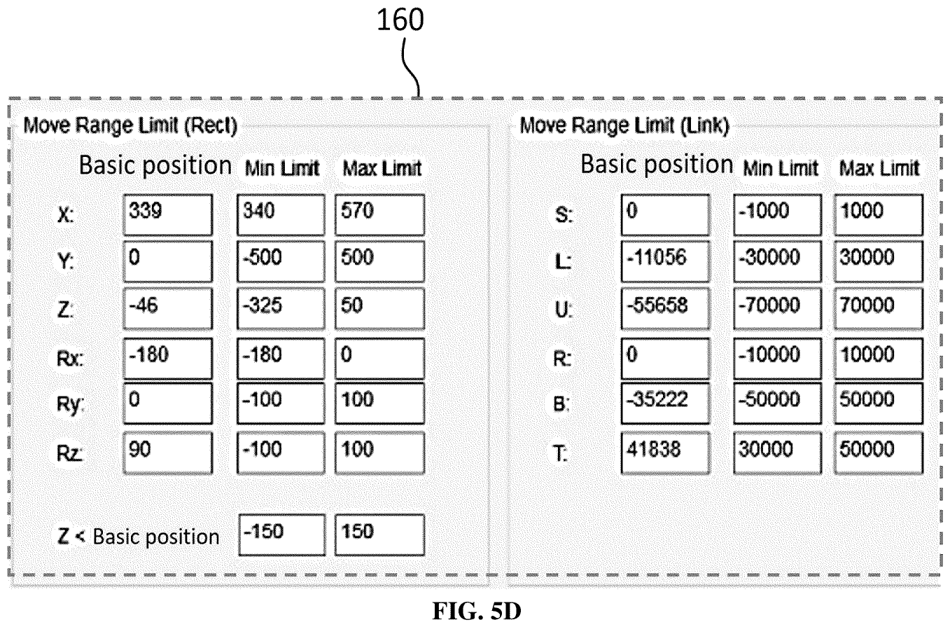

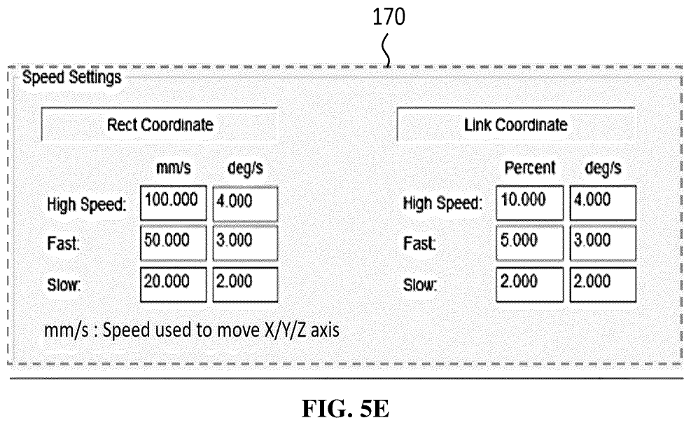

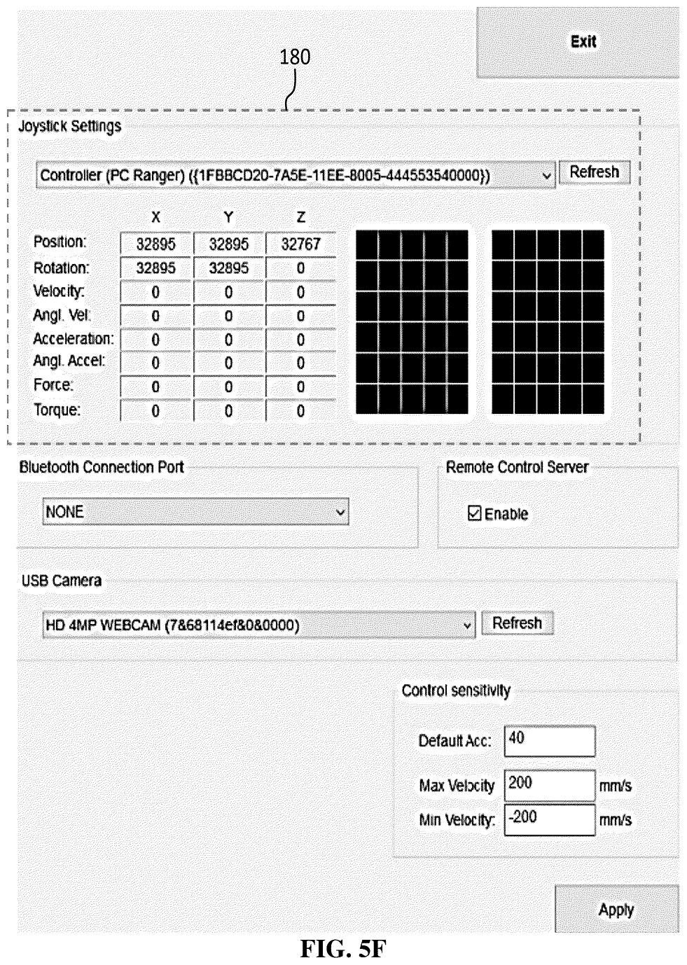

FIG. 3 is a block diagram showing a function performed by the processor of the remote robot control system according to the present invention, and FIGS. 4A to 5F are diagrams showing a control interface provided by the remote robot control system.

For reference, some or all of the blocks shown in FIG. 3 may be implemented as hardware and/or software components that execute a specific function. The functions performed by the blocks shown in FIG. 3 may be implemented by one or more microprocessors, or may be implemented by circuit configurations for the corresponding functions. Some or all of the blocks shown in FIG. 3 may be software modules configured in various programming languages or scripting languages executed on the processor.

Referring to FIGS. 3 to 5F, the processor 100 of the remote robot control system 10 according to one embodiment of the present invention may include a robot control unit 110, a state display unit 120, an image output unit 130, an alarm output unit 140, robot connection setting units 21 and 150, an operation range setting unit 160, a driving speed setting unit 170, and a controller setting unit 180.

In this case, the robot controller 110, the state display unit 120, the image output unit 130, the alarm output unit 140, the robot connection setting units 21 and 150, the operation range setting unit 160, the driving speed setting unit 170, and the controller setting unit 180 may be provided in the form of a control interface, but the present invention is not limited thereto.

In addition, the above-described control interface may be provided with a switching tab 105 including a running button for setting activation/deactivation of robot control, a main button for switching to a main screen, and a setting button for switching to a setting screen.

The robot control unit 110 selects at least one controller 2 and controls the robot 1 according to the control command input from the selected controller 2, and may include a controller display unit 111, a driving coordinate setting unit 112, an operation button unit 113, a servo control unit 114, and a robot position display unit 115.

The robot control unit 110 displays a type of the controller 2 that is currently selected, selects driving coordinates of the robot 1, displays position information about the robot 1 according to the selected driving coordinates, and provides an operation button for inputting the control command.

In addition, the controller display unit 111 displays the controller 2 that is currently selected, and when a plurality of types of the controller 2 are connected, one controller 2 is selected and displayed according to the control priority.

In addition, the driving coordinate setting unit 112 is for setting the driving coordinates of the robot 1, and when a RECT button is selected, orthogonal coordinates may be set as the driving coordinates, and when a LINK button is selected, link coordinates may be set as the driving coordinates.

In addition, the operation button unit 113 may be used when the controller 2 is selected as a mouse, and may control each axis of the robot 1 or move the robot 1 to a basic position, and may not operate when the remote client and the joystick are selected as the controller 2.

In addition, the servo control unit 114 may control turning on/off of a servo motor mounted on the robot 1, and may control turning on/off of a hold function.

In addition, the robot position display unit 115 may display position information of the robot 1, and in particular, may display a coordinate value corresponding to orthogonal coordinates as the position information according to the driving coordinates set in the driving coordinate setting unit 112, or may display a coordinate value corresponding to the link coordinates as the position information.

The state display unit 120 displays information about states of the robot 1 and controller 2, and may include a connection state display unit 121, an operation state log display unit 122, and an IP display unit 123.

The state display unit 120 may further display an operation log including a change in connection states of the robot 1 and the controller 2 while displaying the connection states of the robot 1 and the controller 2.

In addition, the connection state display unit 121 may display connection states of the joystick, the robot 1, and the remote client.

In addition, when an important change state such as a change in the connection state occurs, the operation state log display unit 122 displays an operation state log corresponding thereto.

In addition, the IP display unit 123 displays an IP allocated to the remote robot control system 10, and in this case, the remote client or the like may be connected based on the displayed IP.

The image output unit 130 outputs the image data obtained by photographing a working state or working situation of the robot 1.

When the robot 1 operates according to the control command, the image output unit 130 may receive the image data from the image photographing device 3 and output the received image data in real time.

The alarm output unit 140 is configured to receive one or more alarms for an abnormal state from the robot 1, output the received alarms, and stop the alarms that are previously output, and may include an alarm list display unit 141 and an alarm reset unit 142.

In addition, the alarm list display unit 141 sequentially displays the alarms generated during the operation of the robot 1 and contents thereof.

In addition, the alarm reset unit 142 may reset or stop the previously output alarms. In this case, it is preferable to reset the alarm after the abnormal state, error, and the like are resolved.

The robot connection setting units 21 and 150 may set an IP allocated to the robot 1, a packet reception waiting time, and the number of retries. In this case, the IP allocated to the robot may be confirmed through a pendant.

The operation range setting unit 160 may set a basic position of the robot 1, may set an operable range for each axis in terms of the orthogonal coordinates and the link coordinates, and may set a driving limitation section with respect to at least one axis of the robot 1.

The operation range setting unit 160 may set a basic position, a minimum value, and a maximum value for each axis, and may set a driving restriction section for a Z-axis of the robot 1 to prevent collision with a structure when the robot 1 moves left and right.

The driving speed setting unit 170 sets a driving speed of the robot 1.

The driving speed setting unit 170 is configured as the driving speed is set as a driving speed in association with the orthogonal coordinates and a driving speed in association with the link coordinates.

The controller setting unit 180 displays a list of connectable controllers 2, sets a connection with the corresponding controller 2 to allow the robot control unit 110 to select the corresponding controller 2, and displays an operation state of the controller 2 that has been connected.

Meanwhile, the robot connection setting units 21 and 150, the operation range setting unit 160, the driving speed setting unit 170, and the controller setting unit 180, which are described above, may select a setting button of the switching tab 105 to enable setting or input on the switched setting screen.

In addition, the above-described setting screen may further include a function unit for setting activation of a remote control server that activates or deactivates a server function for remote control and for setting a Bluetooth connection in order to set a connection of a Bluetooth device.

Hereinafter, a control interface 20 for a controller provided in the controller 2 by the remote robot control system 10 according to one embodiment of the present invention will be described.

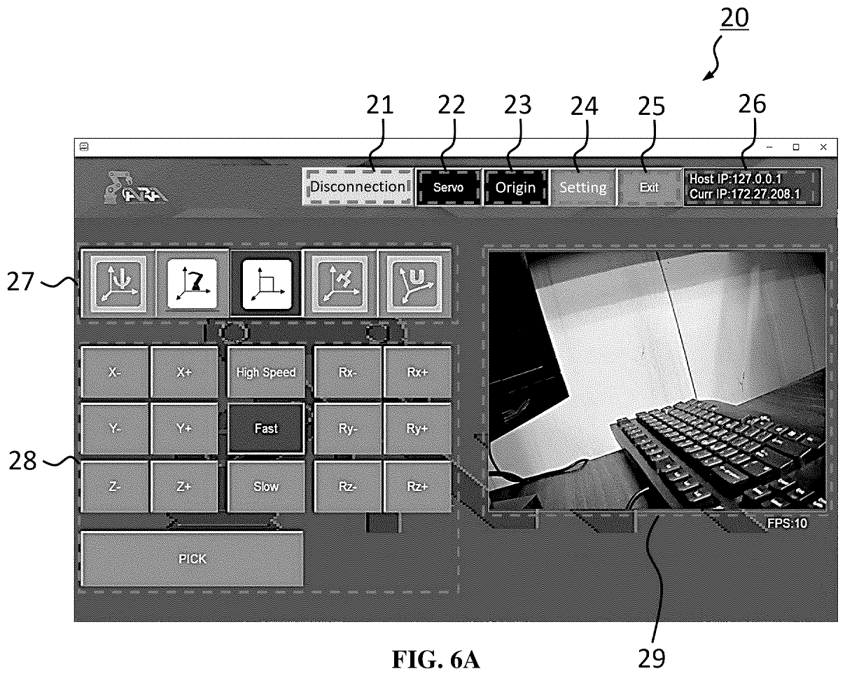

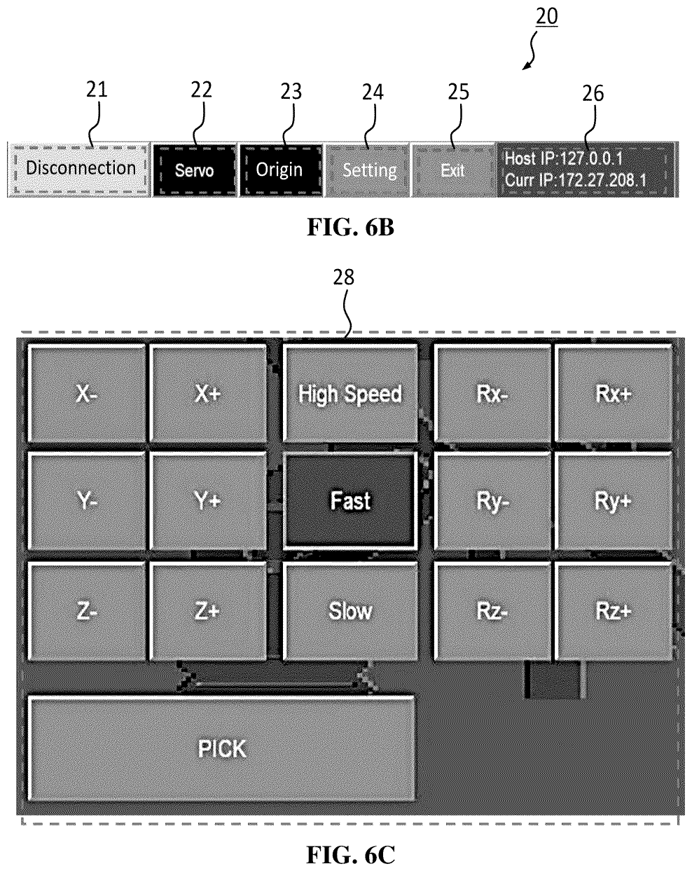

FIG. 6A is a diagram showing the control interface 20 for a controller provided from the remote robot control system to the controller and FIGS. 6B to 6C are enlarged views showing portions of FIG. 6A.

Referring to FIGS. 6A to 6C, the control interface 20 for a controller of the remote robot control system 10 according to one embodiment of the present invention may be installed in a remote client selected by the controller 2, and may include a connection setting unit 21, a servo control unit 22, an origin movement unit 23, a setting unit 24, a termination unit 25, an IP display unit 26, a driving coordinate selection unit 27, an operation button unit 28, and an image output unit 29.

The connection setting unit 21 may be connected to or disconnected from the remote robot control system 10, the servo control unit 22 may remotely control turning on/off of the servo motor mounted on the robot 1, and the origin movement unit 23 may move the robot 1 to a predefined origin, that is, a basic position.

The setting unit 24 may input an IP for a connection with the remote robot control system 10 or set a button delay by calling a setting screen or a setting tab, and the termination unit 25 may allow the control interface 20 for a controller to be terminated by the controller 2.

The IP display unit 26 may display the IP of the remote robot control system 10 and a remote client IP selected by the controller 2, the driving coordinate selection unit 27 may set orthogonal coordinates or link coordinates as driving coordinates, and the operation button unit 28 may control each axis of the robot 1 or move the robot 1 to the basic position.

The image output unit 29 receives the image data obtained by photographing a working state or working situation of the robot 1 from the remote robot control system 10, and outputs the photographed image data in real time.

Hereinabove, the preferred embodiment of the present invention have been exemplarily described, but the scope of the present invention is not limited to such a specific embodiment, and may be appropriately changed within the scope described in the claims.

What is claimed is:

1. A remote robot control system for controlling a robot, the remote robot control system comprising:
a robot control unit configured to select at least one controller and control the robot according to a control command input from the selected controller;
a state display unit configured to display information about states of the robot and the controller; and
an image output unit configured to receive image data from an image photographing device installed in the robot or installed around the robot and output the received image data in real time when the robot operates according to the control command.

2. The remote robot control system of claim 1, further comprising an alarm output unit configured to receive one or more alarms for an abnormal state from the robot, output the received alarms, and stop an alarm that is previously output.

3. The remote robot control system of claim 1, further comprising an operation range setting unit configured to set a basic position of the robot, set an operable range for each axis in terms of orthogonal coordinates and link coordinates, and set a driving limitation section with respect to at least one axis of the robot.

4. The remote robot control system of claim 1, further comprising a driving speed setting unit configured to set a driving speed of the robot, in which the driving speed is set as a driving speed in association with orthogonal coordinates and a driving speed in association with link coordinates.

5. The remote robot control system of claim 1, further comprising a controller setting unit configured to display a list of connectable controllers, set a connection with a corresponding controller to allow the robot control unit to select the corresponding controller, and display an operation state of the controller that has been connected.

6. The remote robot control system of claim 1, wherein the robot control unit displays a type of a controller that is currently selected, selects driving coordinates of the robot, displays position information about the robot according to the selected driving coordinates, and provides an operation button for inputting the control command.

7. The remote robot control system of claim 1, wherein the state display unit further displays an operation log including a change in connection states of the robot and the controller while displaying the connection states of the robot and the controller.
